(19) United States
(12) Patent Application Publication
(10) Pub. No.: US 2025/0356531 A1
(43) Pub. Date: Nov. 20, 2025

(54) INFORMATION PROCESSING APPARATUS, INFORMATION PROCESSING METHOD, AND RECORDING MEDIUM

(71) Applicant: NEC Corporation, Tokyo (JP)

(72) Inventors: Kenkoh Endoh, Tokyo (JP); Midori Shimura, Tokyo (JP); Shukichi Tanaka, Tokyo (JP)

(73) Assignee: NEC Corporation, Tokyo (JP)

(21) Appl. No.: 19/206,171

(22) Filed: May 13, 2025

(30) Foreign Application Priority Data
May 20, 2024 (JP) 2024-081967

(51) Int. Cl. G06T 7/90

(52) U.S. Cl. CPC G06T 7/90

(57) ABSTRACT

Provided is an information processing apparatus capable of suitably carrying out a color matching prediction with respect to a plastic material which includes waste plastic. The information processing apparatus includes: an acquiring means for acquiring one of pieces of information which are color information and pigment information, and features of waste plastic; and a predicting means for predicting the other one of the pieces of information from information acquired by the acquiring means, with use of a prediction model which has learned a mutual relationship among pigment information, features of waste plastic, and color information.

### CROSS REFERENCE TO RELATED APPLICATIONS

This application is based upon and claims the benefit of priority from Japanese Patent Application No. 2024-081967 filed on May 20, 2024, the disclosure of which is incorporated herein in its entirety by reference.

### TECHNICAL FIELD

The present disclosure relates to an information processing apparatus, an information processing method, and a recording medium.

### BACKGROUND ART

Techniques for carrying out a color matching prediction regarding plastic materials are known. For example, Patent Literature 1 discloses a technique for predicting data on the hue of a coating based on color matching, with respect to paint which includes a resin.

### CITATION LIST

### Patent Literature

### Patent Literature 1

Japanese Patent Application Publication Tokukai No. 2021-188046

### SUMMARY OF INVENTION

### Technical Problem

With the technique disclosed in Patent Literature 1, it is difficult to carry out a color matching prediction regarding plastic materials which include waste plastic, because unlike the case with a virgin material, the simple addition rule for pigment data does not hold true for a plastic material which includes waste plastic.

The present disclosure has been made in view of the above problem, and an example object thereof is to provide a technique for suitably carry out a color matching prediction regarding a plastic material which includes waste plastic.

### Solution to Problem

An information processing apparatus in accordance with an example aspect of the present disclosure includes at least one processor, and the at least one processor carries out: an acquiring process of acquiring one of pieces of information which are color information and pigment information, and features of waste plastic; and a predicting process of predicting the other one of the pieces of information from information acquired by the acquiring process, with use of a prediction model which has learned a mutual relationship among pigment information, features of waste plastic, and color information.

An information processing apparatus in accordance with an example aspect of the present disclosure includes at least one processor, and the at least one processor carries out: an acquiring process of acquiring one of pieces of information which are color information and pigment information, and features of waste plastic; and a training process of referring to information acquired by the acquiring process, to train a prediction model for predicting a mutual relationship among pigment information, features of waste plastic, and color information.

An information processing method in accordance with an example aspect of the present disclosure includes: at least one processor acquiring one of pieces of information which are color information and pigment information, and features of waste plastic; and the at least one processor predicting the other one of the pieces of information from information acquired in the acquiring, with use of a prediction model which has learned a mutual relationship among pigment information, features of waste plastic, and color information.

An information processing method in accordance with an example aspect of the present disclosure includes: at least one processor acquiring one of pieces of information which are color information and pigment information, and features of waste plastic; and the at least one processor referring to information acquired by the acquiring, to train a prediction model for predicting a mutual relationship among pigment information, features of waste plastic, and color information.

A non-transitory recording medium in accordance with an example aspect of the present disclosure is a non-transitory recording medium storing a program for causing a computer to function as an information processing apparatus, and the program causes the computer to carry out: an acquiring process of acquiring one of pieces of information which are color information and pigment information, and features of waste plastic; and a predicting process of predicting the other one of the pieces of information from information acquired by the acquiring process, with use of a prediction model which has learned a mutual relationship among pigment information, features of waste plastic, and color information.

A non-transitory recording medium in accordance with an example aspect of the present disclosure is a non-transitory recording medium storing a program for causing a computer to function as an information processing apparatus, and the program causes the computer to carry out: an acquiring process of acquiring one of pieces of information which are color information and pigment information, and features of waste plastic; and a training process of referring to information acquired by the acquiring process, to train a prediction model for predicting a mutual relationship among pigment information, features of waste plastic, and color information.

### Advantageous Effects of Invention

An example aspect of the present disclosure provides an example advantage of making it possible to provide a technique for suitably carrying out a color matching prediction regarding a plastic material which includes waste plastic.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of an information processing method in accordance with the present disclosure.

FIG. 3 is a block diagram illustrating a configuration of an information processing apparatus in accordance with the present disclosure.

FIG. 4 is a flowchart illustrating a flow of an information processing method in accordance with the present disclosure.

FIG. 5 is a block diagram illustrating a configuration of an information processing apparatus in accordance with the present disclosure.

FIG. 6 is a diagram for explaining information processing in accordance with the present disclosure.

FIG. 7 is a diagram for explaining information processing in accordance with the present disclosure.

FIG. 8 is a diagram for explaining information processing in accordance with the present disclosure.

FIG. 9 is a diagram for explaining information processing in accordance with the present disclosure.

FIG. 10 is a representation of an example display produced by the information processing apparatus in accordance with the present disclosure.

FIG. 11 is a diagram for explaining information processing in accordance with the present disclosure.

FIG. 12 is a diagram for explaining information processing in accordance with the present disclosure.

FIG. 13 is a diagram for explaining information processing in accordance with the present disclosure.

FIG. 14 is a representation of an example display produced by the information processing apparatus in accordance with the present disclosure.

FIG. 15 is a diagram for explaining information processing in accordance with the present disclosure.

FIG. 16 is a block diagram illustrating a configuration of an information processing apparatus in accordance with the present disclosure.

FIG. 17 is a block diagram illustrating a configuration of a computer which functions as the information processing apparatuses in accordance with the present disclosure.

### EXAMPLE EMBODIMENTS

The following description will discuss example embodiments of the present invention. However, the present invention is not limited to the example embodiments described below, but can be altered by a skilled person in the art within the scope of the claims. For example, any embodiment derived by appropriately combining techniques (some or all of products or methods) adopted in differing example embodiments described below can be within the scope of the present invention. Further, any embodiment derived by appropriately omitting one or more of the techniques adopted in differing example embodiments described below can be within the scope of the present invention. Furthermore, the advantage mentioned in each of the example embodiments described below is an example advantage expected in that example embodiment, and does not define the extension of the present invention. That is, any embodiment which does not provide any of the example advantages mentioned in the example embodiments described below can also be within the scope of the present invention.

### First Example Embodiment

The following description will discuss a first example embodiment, which is an example embodiment of the present invention, in detail with reference to the drawings. The present example embodiment is basic to each of the example embodiments which will be described later. It should be noted that the applicability of the techniques adopted in the present example embodiment is not limited to the present example embodiment. That is, the techniques adopted in the present example embodiment can be adopted in another example embodiment included in the present disclosure, to the extent of constituting no specific technical obstacle. Further, the techniques illustrated in the drawings referred to for the description of the present example embodiment can be adopted in another example embodiment included in the present disclosure, to the extent of constituting no specific technical obstacle.

### Configuration of Information Processing Apparatus 1

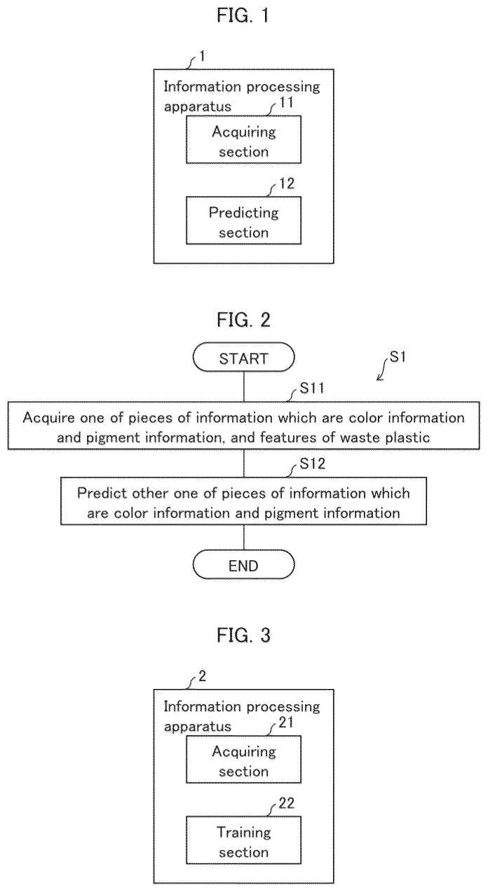

The configuration of an information processing apparatus 1 in accordance with the present example embodiment is described here with reference to FIG. 1. FIG. 1 is a block diagram illustrating the configuration of the information processing apparatus 1. The information processing apparatus 1 includes an acquiring section 11 and a predicting section 12, as illustrated in FIG. 1.

### Acquiring Section 11

The acquiring section 11 acquires one of pieces of information which are color information and pigment information, and features of waste plastic. As an example, the color information acquired by the acquiring section 11 is target color information which indicates a color that serves as a target. As an example, the pigment information acquired by the acquiring section 11 is pigment composition candidate information which indicates a usable pigment composition.

As an example, the “features of waste plastic” acquired by the acquiring section 11 may be
numerical information which indicates the characteristics of the waste plastic, or may be
information which quantitatively indicates, with use of numerical values, non-numerical information such as classification information or qualitative information regarding the waste plastic, in a form capable of being referred to by a machine-learned model (e.g., a prediction model which will be described later).

As used herein, the term “waste plastic” does not preclude the inclusion of a virgin material. In other words, the “waste plastic” used herein may be
made only of waste plastic, or may be
a mixed material of waste plastic and a virgin plastic material.

Although the pieces of information acquired by the acquiring section 11 are, for example, information referred to in an inference phase, this wording does not limit the present example embodiment.

### (Predicting Section 12)

The predicting section 12 uses a trained prediction model to predict the other one of the pieces of information, which are the color information and the pigment information, from the information acquired by the acquiring section 11. The prediction model is, for example, a prediction model which has learned a mutual relationship among pigment information, features of waste plastic, and color information. More specific examples of the prediction model used by the predicting section 12 may include:

### (Prediction Model 1)

a prediction model for predicting, from pigment information and features of waste plastic, color information which indicates a color obtained by applying a pigment indicated by the pigment information to the waste plastic; and

### (Prediction Model 2)

a prediction model for predicting, from color information and features of waste plastic, pigment information which indicates a pigment that imparts, to the waste plastic, a color indicated by the color information.

Further, the predicting section 12 uses these prediction models to carry out at least one of the following processes:

### (Predicting Process 1)

a process of predicting, from the pigment information acquired by the acquiring section 11 and the features of the waste plastic, color information which indicates a color corresponding to the pigment information; and

### (Predicting Process 2)

a process of predicting, from the color information acquired by the acquiring section 11 and the features of the waste plastic, pigment information which indicates a pigment corresponding to the color information.

Any combination of the prediction models 1 and 2 and the predicting processes 1 and 2 may be employed. Specific examples of the predicting process which may be carried out by the predicting section 12 include the following four predicting processes.

### Example 1-1: Prediction Model 1×Predicting Process 1

A process of inputting the pigment information acquired by the acquiring section 11 and the features of the waste plastic to
a prediction model (prediction model 1 above) for predicting, from pigment information and features of waste plastic, color information which indicates a color obtained by applying a pigment indicated by the pigment information to the waste plastic, to predict color information which indicates a color corresponding to the pigment information acquired by the acquiring section 11.

### Example 1-2: Prediction Model 1×Predicting Process 2

A process of referring to the color information acquired by the acquiring section 11 and the features of the waste plastic, and using
a prediction model (prediction model 1 above) for predicting, from pigment information and features of waste plastic, color information which indicates a color obtained by applying a pigment indicated by the pigment information to the waste plastic, to predict pigment information which indicates a pigment corresponding to the color information acquired by the acquiring section 11.

In this case, as an example, the predicting section 12 carries out the process of predicting pigment information which indicates a pigment corresponding to the color information acquired by the acquiring section 11, by inputting a plurality of pigment information candidates to the prediction model 1 to predict a color corresponding to each of the candidates and carrying out a search process so that the color approaches a color indicated by the color information acquired by the acquiring section 11.

### Example 2-1: Prediction Model 2×Predicting Process 1

A process of referring to the pigment information acquired by the acquiring section 11 and the features of the waste plastic, and using
a prediction model (prediction model 2 above) for predicting, from color information and features of waste plastic, pigment information which indicates a pigment that imparts, to the waste plastic, a color indicated by the color information, to predict color information which indicates a color corresponding to the pigment information acquired by the acquiring section 11.

In this case, as an example, the predicting section 12 carries out the process of predict color information which indicates a color corresponding to the pigment information acquired by the acquiring section 11, by inputting a plurality of color information candidates to the prediction model 1 to predict pigment information corresponding to each of the candidates and carrying out a search process so that the pigment information approaches the pigment information acquired by the acquiring section 11.

### Example 2-2: Prediction Model 2×Predicting Process 2

A process of inputting the color information acquired by the acquiring section 11 and the features of the waste plastic to
a prediction model (prediction model 2 above) for predicting, from color information and features of waste plastic, pigment information which indicates a pigment that imparts, to the waste plastic, a color indicated by the color information, to predict pigment information which indicates a pigment corresponding to the color information acquired by the acquiring section 11.

A specific configuration of the prediction model used by the predicting section 12 does not limit the present example embodiment. As an example, the prediction model may be a deep learning model having a plurality of layers, or may be any other model. Further, the prediction model may be trained by supervised learning, or may be trained by unsupervised learning or semi-supervised learning.

As an example, a prediction result derived by the predicting section 12 is
presented to a user via an output section (not illustrated), and/or
provided to an external production apparatus via a communicating section (not illustrated) to be used for color matching of a plastic material which includes waste plastic.

### Example Advantage of Information Processing Apparatus 1

As above, in the information processing apparatus 1,
at least one of pieces of information which are color information and pigment information, and features of waste plastic are acquired, and
the other information of the pieces of information is predicted from the acquired information, with use of a prediction model which has learned a mutual relationship among pigment information, features of waste plastic, and color information.

As above, in the information processing apparatus 1, features of waste plastic are referred to, so that from one of pieces of information which are color information and pigment information, the other of the pieces of information is predicted. This makes it possible to suitably carry out a color matching prediction regarding a plastic material which includes waste plastic.

### (Flow of Information Processing Method S1)

Next, the flow of an information processing method S1 in accordance with the present example embodiment is described here with reference to FIG. 2. FIG. 2 is a flowchart illustrating the flow of the information processing method S1. The information processing method S1 includes an acquiring process (acquiring step) S11 and a predicting process (predicting step) S12, as illustrated in FIG. 2.

### (Step S11)

In step S11, the acquiring section 11 acquires one of pieces of information which are color information and pigment information, and features of waste plastic. The first acquiring section 11 is described above in more detail, and the description thereof is therefore omitted here.

### (Step S12)

In step S12, the predicting section 12 predicts the other one of the pieces of information, which are the color information and the pigment information, from the acquired information, with use of a prediction model which has learned a mutual relationship among pigment information, features of waste plastic, and color information. The predicting section 12 is described above in more detail, and the description thereof is therefore omitted here.

### (Example Advantage of Information Processing Method S1)

As above, in the information processing method S1,
at least one of pieces of information which are color information and pigment information, and features of waste plastic are acquired, and
the other information of the pieces of information is predicted from the acquired information, with use of a prediction model which has learned a mutual relationship among pigment information, features of waste plastic, and color information. This configuration provides an example advantage similar to that provided by the information processing apparatus 1.

### (Configuration of Information Processing Apparatus 2)

Next, the configuration of an information processing apparatus 2 in accordance with the present example embodiment is described here with reference to FIG. 3. FIG. 3 is a block diagram illustrating the configuration of the information processing apparatus 2. The information processing apparatus 2 includes an acquiring section 21 and a training section 22, as illustrated in FIG. 3.

### (Acquiring Section 21)

The acquiring section 21 acquires one of pieces of information which are color information and pigment information, and features of waste plastic.

Since the color information, the pigment information, and the features of the waste plastic are substantially the same as those described for the information processing apparatus 1, the same descriptions are omitted here. Although the pieces of information acquired by the acquiring section 21 are, for example, information referred to in a training phase, this wording does not limit the present example embodiment.

### (Training Section 22)

The training section 22 refers to the information acquired by the acquiring section 21, to train a prediction model for predicting a mutual relationship among pigment information, features of waste plastic, and color information.

As an example, the training section 22 trains at least one of the following models:

### (Prediction Model 1)

a prediction model for predicting, from pigment information and features of waste plastic, color information which indicates a color obtained by applying a pigment indicated by the pigment information to the waste plastic; and

### (Prediction Model 2)

a prediction model for predicting, from color information and features of waste plastic, pigment information which indicates a pigment that imparts, to the waste plastic, a color indicated by the color information. Further, the training section 22 may acquire a ground-truth label via the acquiring section 21, and train the prediction model by supervised learning in which the acquired ground-truth label is referred to. As an example, the training section 22 may carry out the training process indicated below by way of example.

### (Training Process 1)

As an example, the training section 22 inputs training data acquired by the acquiring section 21 to a prediction model (prediction model 1) for predicting, from pigment information and features of waste plastic, color information which indicates a color obtained by applying a pigment indicated by the pigment information to the waste plastic. The training data includes:
pigment information; and
features of waste plastic, and the training data is associated with
an actual color (ground-truth label) obtained by applying a pigment indicated by the pigment information to the waste plastic.

The training section 22 then updates one or more parameters of the prediction model 1, so that a color indicated by the prediction result outputted by the prediction model 1 which has the training data inputted thereto approaches the color indicated by the ground-truth label.

### (Training Process 2)

As another example, the training section 22 inputs the training data acquired by the acquiring section 21 to a prediction model (prediction model 2) for predicting, from color information and features of waste plastic, pigment information which indicates a pigment that imparts, to the waste plastic, a color indicated by the color information. The training data includes:
color information; and
features of waste plastic, and
the training data is associated with
pigment information (ground-truth label) which indicates an actual pigment that imparts, to the waste plastic, a color indicated by the color information. The training section 22 then updates one or more parameters of the prediction model 2, so that the pigment information indicated by the prediction result outputted by the prediction model 2 which has the training data inputted thereto approaches pigment information indicated by the ground-truth label.

A specific configuration of the prediction model trained by the training section 22 does not limit the present example embodiment. As an example, the prediction model may be a deep learning model having a plurality of layers, or may be any other model. Further, the prediction model may be trained by supervised learning, or may be trained by unsupervised learning or semi-supervised learning.

The prediction model having been trained by the training section 22 is stored in, for example, a storage section (not illustrated) and referred to in an inference phase. As an example, the prediction model having been trained by the training section 22 is used for the predicting process by the predicting section 12 of the information processing apparatus 1 described above.

### (Example Advantage of Information Processing Apparatus 2)

As above, in the information processing apparatus 2,
at least one of pieces of information which are color information and pigment information, and features of waste plastic are acquired, and
a prediction model for predicting a mutual relationship among pigment information, features of waste plastic, and color information is trained with reference to the acquired information.

As above, in the information processing apparatus 2, a prediction model for predicting a mutual relationship among pigment information, features of waste plastic, and color information is trained with reference to the features of the waste plastic. This makes it possible to generate a prediction model capable of suitably carrying out a prediction regarding color matching of a plastic material which includes waste plastic. Thus, with this configuration, it is possible to suitably carry out a color matching prediction regarding a plastic material which includes waste plastic.

### (Flow of Information Processing Method S2)

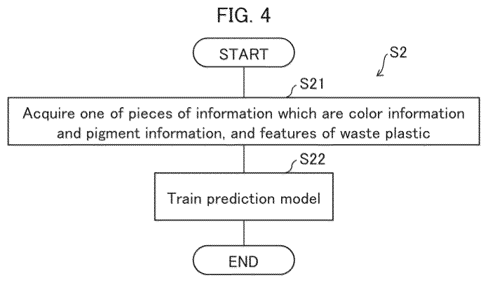

Next, the flow of an information processing method S2 in accordance with the present example embodiment is described here with reference to FIG. 4. FIG. 4 is a flowchart illustrating the flow of the information processing method S2. The information processing method S2 includes an acquiring process (acquiring step) S21 and training process (training step) S22, as illustrated in FIG. 4.

### (Step S21)

In step S21, the acquiring section 21 acquires one of pieces of information which are color information and pigment information, and features of waste plastic. The acquiring section 21 is described above in more detail, and the description thereof is therefore omitted here.

### (Step S22)

In step S22, the training section 22 refers to the acquired information, to train a prediction model for predicting a mutual relationship among pigment information, features of waste plastic, and color information. The training section 22 is described above in more detail, and the description thereof is therefore omitted here.

### (Example Advantage of Information Processing Method S2)

As above, in the information processing method S2,
at least one of pieces of information which are color information and pigment information, and features of waste plastic are acquired, and
a prediction model for predicting a mutual relationship among pigment information, features of waste plastic, and color information is trained with reference to the acquired information.

This configuration provides an example advantage similar to that provided by the information processing apparatus 2.

### Second Example Embodiment

The following description will discuss a second example embodiment, which is an example embodiment of the present invention, in detail with reference to the drawings. A component having the same function as a component described in the above example embodiment is assigned the same reference sign, and the description thereof is omitted where appropriate. It should be noted that the applicability of the techniques adopted in the present example embodiment is not limited to the present example embodiment. That is, the techniques adopted in the present example embodiment can be adopted in another example embodiment included in the present disclosure, to the extent of constituting no specific technical obstacle. Further, the techniques illustrated in the drawings referred to for the description of the present example embodiment can be adopted in another example embodiment included in the present disclosure, to the extent of constituting no specific technical obstacle.

### (Configuration of Information Processing System 1A)

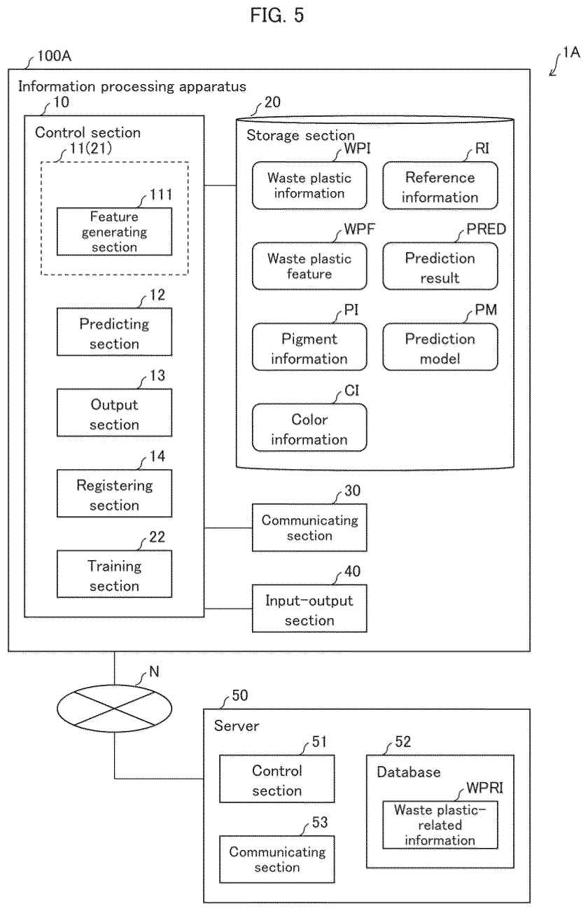

The configuration of an information processing system 1A in accordance with the present example embodiment is described here with reference to FIG. 5. FIG. 5 is a block diagram illustrating the configuration of the information processing system 1A. The information processing system 1A includes an information processing apparatus 100A and a server 50 connected to the information processing apparatus 100A via a network N, as illustrated in FIG. 5. As an example and without limiting the present example embodiment, a specific configuration of the network N can include a wireless local area network (LAN), a wired LAN, a wide area network (WAN), a public network, a mobile data communication network, and a combination thereof.

### (Server 50)

The server 50 includes a control section 51, a database 52, and a communicating section 53, as illustrated in FIG. 5. The communicating section 53 communicates with an apparatus external to the server 50. As an example, the communicating section 53 communicates with the information processing apparatus 100A of the information processing system 1A or any other external apparatus (not illustrated) connected via the network N. The communicating section 53 transmits data supplied by the control section 51 to the information processing apparatus 100A and supplies the control section 51 with data received from the information processing apparatus 100A. The data that the communicating section 53 transmits to and receives from the information processing apparatus 100A can include at least one selected from the group consisting of waste plastic information WPI, a waste plastic feature WPF, pigment information PI, and color information CI.

### (Database 52)

As an example, the database 52 has stored therein waste plastic-related information WPRI, which is information related to waste plastic. As an example, the waste plastic-related information WPRI can be generated by a control section 10 of the information processing apparatus 100A and recorded on a database such as the database 52.

As an example, the waste plastic-related information WPRI may include a contribution degree to which the waste plastic feature WPF contribute to the prediction of the pigment information PI or the color information CI carried out by the predicting section 12. As an example, the contribution degree of the waste plastic feature WPF indicates an extent to which a plurality of waste plastic features WPF each contribute to the prediction of the pigment information PI or the color information CI carried out by the predicting section 12. For example, the contribution degree of the waste plastic feature WPF may be indicated by a proportion with respect to the sum of the contribution degrees, and may be indicated by a real number of 0 to 1 or a value of 0% to 100%. As an example, the contribution degree of the waste plastic feature WPF may be computed from a prediction result PRED derived by the predicting section 12, with use of a known technique. This configuration enables a user to suitably determine, for example, the waste plastic feature WPF that is effective in reproducing a certain pigment information PI or a certain color information CI. As a specific example, in developing a recycled waste plastic-containing product, it is possible for a user to suitably determine waste plastic features that affect color production of the product, by referring to the waste plastic-related information WPRI.

As part of environmental protection, in order for the amount of plastic waste generated in the entire supply chain to be managed, there is demand that the amount of usage of waste plastic in a recycled waste plastic-containing product should be determined. As such, for example, the waste plastic-related information WPRI may include information in which the waste plastic feature WPF inputted to a prediction model PM and the color information CI outputted from the prediction model PM in response to the input are associated with each other. In this case, for example, a user may refer to the waste plastic-related information WPRI to determine, from the color information CI which indicates the color of the recycled waste plastic-containing product, the amount of usage of each of the waste plastic materials in the product. The amount of usage of each of the waste plastic materials may be determined from, for example, information such as the mixing proportion of a specific waste plastic material included in the waste plastic feature WPF. Further, as an example, the waste plastic-related information WPRI may include information in which the waste plastic feature WPF inputted to the prediction model PM and the pigment information PI outputted from the prediction model PM in response to the input are associated with each other. In this case, for example, a user may refer to the waste plastic-related information WPRI to determine, from the pigment information PI which indicates the pigment composition of a recycled waste plastic-containing product, the amount of usage of each of the waste plastic materials in the product.

### (Control Section 51)

The control section 51 updates the waste plastic-related information WPRI stored in the database 52.

As an example, the control section 51 carries out addition or an update with respect to the database 52, regarding the information which is received from the information processing apparatus 100A and in which the waste plastic feature WPF inputted to the prediction model PM is associated with the color information CI or the pigment information PI outputted from the prediction model PM in response to the input.

As an example, the control section 51 may compute the contribution degree of the waste plastic feature WPF from the prediction result PRED derived by the predicting section 12. With this, as an example, the control section 51 may carry out addition or an update with respect to the database 52, regarding information in which the computed contribution degree of the waste plastic feature WPF and the prediction result PRED are associated with each other.

In the present example embodiment, the server 50 is an apparatus separate from the information processing apparatus 100A, by way of example and without limiting the present example embodiment. A control section of the information processing apparatus 100A may have the functions of the control section 51 of the server 50 or the control section 51 that serves as a database updating section and a contribution degree computing section. Similarly, the waste plastic-related information WPRI stored in the database 52 of the server 50 may be stored in a storage section of the information processing apparatus 100A so that the information processing apparatus 100A itself can update the waste plastic-related information WPRI.

### (Configuration of Information Processing Apparatus 100A)

The configuration of the information processing apparatus 100A in accordance with the present example embodiment is described here with reference to FIG. 5. The information processing apparatus 100A includes a control section 10, a storage section 20, a communicating section 30, and an input-output section 40, as illustrated in FIG. 5.

### (Communicating Section 30)

The communicating section 30 communicates with an apparatus external to the information processing apparatus 100A. As an example, the communicating section 30 communicates with the server 50. The communicating section 30 transmits data supplied by the control section 10 to the server 50 and supplies the control section 10 with data received from the server 50.

### (Input-Output Section 40)

The input-output section 40 has such a configuration as to include at least one of pieces of input-output equipment such as a keyboard, a mouse, a display, a printer, and a touch panel. Alternatively, the input-output section 40 may be configured such that input/output equipment such as a keyboard, a mouse, a display, a printer, or a touch panel is connected thereto. In a case of this configuration, the input-output section 40 accepts inputs of various kinds of information to the information processing apparatus 100A, via the input equipment connected thereto. Further, the input-output section 40 outputs various kinds of information to output equipment connected thereto, under the control of the control section 10. Examples of the input-output section 40 include an interface such as a universal serial bus (USB).

### (Storage Section 20)

In the storage section 20, various kinds of data referred to by the control section 10 and various kinds of data generated by the control section 10 are stored.

As an example, the storage section 20 has stored therein:
waste plastic information WPI;
a waste plastic feature WPF;
pigment information PI;
color information CI;
reference information RI;
prediction result PRED; and
prediction model PM.

### (Waste Plastic Information WPI)

The waste plastic information WPI is information regarding waste plastic of interest in color matching. As an example, the waste plastic information WPI can include at least one of pieces of information such as:
information regarding a main raw material of the waste plastic of interest;
information regarding a substance mixed into the waste plastic of interest;
information regarding whether the waste plastic of interest is made of a single material;
information regarding the color of the waste plastic of interest;
information indicating the condition (the degree) of mixing of a pigment into the waste plastic of interest;
information regarding the texture of the waste plastic of interest;
information regarding the degree of cleaning of the waste plastic of interest;
information regarding the traceability of the waste plastic of interest;
classification information obtained with reference to the product name or product category of a product which includes the waste plastic of interest; and
information regarding whether the waste plastic of interest falls under waste plastic materials which have been empirically proved to be less affected by pigments. Used as the “information regarding the texture” may be at least one selected from the group consisting of:
a captured image of the waste plastic of interest; and
information obtained by an image analysis of the captured image of the waste plastic of interest.

As the “information obtained by an image analysis of the captured image”, the following may be used:
a result of rule-based classification of the captured image as any of a plurality of categories in the image analysis of the captured image; and
features (feature vector) obtained by embedding the captured image into a feature space in the image analysis. Further, the image analysis and the derivation of the result of the image analysis may be carried out in a feature generating section 111, which will be described later.

The “information regarding the texture” may include
features which are classified with use of mimetic words (expressions of sensation, expressions of feeling) such as slick, harsh, and smooth.

The “information regarding traceability” may include
information regarding whether the waste plastic of interest corresponds to industrial waste or corresponds to domestic waste.

### (Waste Plastic Feature WPF)

The waste plastic feature WPF includes a feature regarding the waste plastic of interest in color matching. The waste plastic feature WPF can be generated by the feature generating section 111 (described later), by way of example and without limiting the present example embodiment.

The waste plastic feature WPF may be expressed as being information which is obtained by processing the waste plastic information WPI so as to enable the waste plastic information WPI to be inputted to the prediction model PM used by the predicting section 12. The waste plastic feature WPF will be described later in detail.

### (Pigment Information PI)

The pigment information PI can include:
pigment information referred to in a training process carried out by the training section 22; and
pigment information referred to in a predicting process carried out by the predicting section 12.

At least part of the pigment information referred to in the training process and at least part of the pigment information referred to in the predicting process may or may not overlap each other. Note that the pigment information PI can be expressed as pigment composition information and as pigment composition.

As an example, the pigment information PI may include information regarding a dye.

### (Color Information CI)

The color information CI can include:
color information referred to in the training process carried out by the training section 22; and
color information referred to in the predicting process carried out by the predicting section 12.

At least part of the color information referred to in the training process and at least part of the color information referred to in the predicting process may or may not overlap each other. The color information CI can be expressed as generated color information and as generated color.

### (Reference Information RI)

As an example, the reference information RI is referred to by the feature generating section 111 (described later), and can include information on colors obtained by applying each of a plurality of types of pigments to each of a plurality of types of waste plastic. As an example, the reference information RI can include
information which indicates the effectiveness (affecting condition, the degree of color production) of each of one or more pigments against each of one or more types of waste plastic.

For example, the reference information RI can include
information which indicates that in a case of using a pigment D1, the waste plastic of a type P1 has a degree of color production of approximately 0.8 with respect to a virgin material, and in a case of using a pigment D2, the waste plastic of the type P1 has a degree of color production of approximately 1.2 with respect to the virgin material.

The reference information RI can therefore be expressed as effective color information. However, such a designation does not limit the present example embodiment. The reference information RI will be described later in more detail.

### (Prediction Result PRED)

The prediction result PRED is information which indicates a prediction result derived by the predicting section 12. A specific example of information included in the prediction result will be described later.

### (Prediction Model PM)

The prediction model PM is trained by the training section 22 and used by the predicting section 12. The prediction model PM may include at least one of the following prediction models:
a prediction model (prediction model PM1) for predicting, from pigment information and features of waste plastic, a color obtained by applying a pigment indicated by the pigment information to the waste plastic; and a prediction model (prediction model PM2) for predicting, from color information and features of waste plastic, a pigment that imparts, to the waste plastic, a color indicated by the color information. The prediction model PM includes a plurality of model parameters, and at least one of the plurality of model parameters is updated by the training process carried out by the training section 22. A specific configuration of the prediction model PM does not limit the present example embodiment. As an example, the prediction model PM may be a deep learning model having a plurality of layers, or may be any other model. Further, the prediction model may be trained by supervised learning, or may be trained by unsupervised learning or semi-supervised learning.

### (Control Section 10)

The control section 10 includes an acquiring section 11, a predicting section 12, an output section 13, a registering section 14, and a training section 22, as illustrated in FIG. 5. Since the acquiring section 11 has functions similar to those of the acquiring section 11 of the information processing apparatus 1 described in the first example embodiment and those of the acquiring section 21 of the information processing apparatus 2 described in the first example embodiment, the acquiring section 11 can be represented by the acquiring section 11(21).

### (Acquiring Section 11)

Like the acquiring section 11 in accordance with the first example embodiment, the acquiring section 11 acquires one of pieces of information which are color information and pigment information, and features of waste plastic. As an example, the color information acquired by the acquiring section 11 may be target color information which indicates a color that serves as a target. As an example, the pigment information acquired by the acquiring section 11 may be pigment composition candidate information which indicates a usable pigment composition. As an example, these pieces of information are referred to in the predicting process carried out by the predicting section 12. As an example, the pigment information acquired by the acquiring section 11 may include information regarding a dye.

Like the acquiring section 21 in accordance with the first example embodiment, the acquiring section 11 may acquire, as information referred to in the training phase, one of the pieces of information, which are the color information and the pigment information, and the features of the waste plastic. The acquiring section 11 can therefore be represented by the acquiring section 11(21). The acquiring section 11 may further acquire a ground-truth label referred to in the training phase. The acquiring section 11 may include the feature generating section 111 as illustrated in FIG. 5.

As an example, the data acquired by the acquiring section 11 may be at least one selected from the group consisting of:
numerical value data; and
the result of recognition of image data which includes at least one selected from the group consisting of color information, pigment information, and a captured image of waste plastic.

As an example, the data acquired by the acquiring section 11 may be inputted by a user via the input-output section 40. As an example, the acquiring section 11 may acquire data which is stored in a database.

### (Feature Generating Section 111)

The feature generating section 111 refers to the waste plastic information WPI regarding waste plastic of interest acquired by the acquiring section 11, to generate a waste plastic feature WPF regarding the waste plastic of interest. As an example, the feature generating process carried out by the feature generating section 111 includes at least one of the following processes.

### (Process 1-1)

A process of including, in the waste plastic feature WPF, the numerical information which is included in the waste plastic information WPI, as numerical information.

### (Process 1-2)

A process of transforming non-numerical information such as the classification information and/or the qualitative information included in the waste plastic information WPI, to numerical information or a one-hot vector and including the numerical information or the one-hot vector in the waste plastic feature WPF.

### (Process 2-1)

A process of generating the items indicated below on the basis of physicochemical hypotheses.
A process of generating features of waste plastic by applying a linear operation (i.e., generating a linear term) to the numerical information included in the waste plastic information WPI or the numerical information generated by the process 1-2.
A process of generating features of waste plastic by applying a non-linear operation (i.e., generating a non-linear term) to the numerical information included in the waste plastic information WPI or the numerical information generated by the process 1-2. (The non-linear operation can include:
   a process of generating a cross term of variables by multiplication of a plurality of types of variables (pieces of numerical information) different from each other; and
   a process of generating non-linear term via a function such as a power function having the second or higher degree, a logarithmic function, or an exponential function, and any other process).
A process of generating a non-linear term which takes, as an argument, the qualitative information (qualitative data) included in the waste plastic information WPI (because qualitative data can be useful additional information in adjusting a change in the condition of color mixing).
A process of generating a term which is dependent on the mixing proportion of a specific waste plastic material in waste plastic of interest (e.g., in a case where the specific waste plastic material worsens the efficacy of a color, a process of using a mixing proportion P of the specific waste plastic material in the waste plastic of interest to generate a term such as min(0.5, exp(−P))).

As an example, the phrase “on the basis of physicochemical hypotheses” means that in generating the above linear term or non-linear term, a function based on a physicochemical law or an empirical rule is used as a function which includes such a term. However, this example does not limit the present example embodiment.

### (Process 2-2)

A process of generating each of the items cited in the above process 2-1 without making a physicochemical hypothesis.

### (Process 3)

A process of generating a correction term referred to in deriving color information or pigment information in the predicting process carried out by the predicting section 12 or the training process carried out by the training section 22 (e.g.,
a process of generating a correction term which is referred to in performing an operation on color information in the predicting process or the training process and which is for correcting the efficacy of a color (how the color is mixed) in waste plastic of interest which includes a specific waste plastic material).

### (Predicting Section 12)

Like the predicting section 12 in accordance with the first example embodiment, the predicting section 12 uses a trained prediction model to predict, from the information acquired by the acquiring section 11, the other one of the pieces of information, which are the color information and the pigment information. The prediction model is, for example, a prediction model which has learned a mutual relationship among pigment information, features of waste plastic, and color information. More specific examples of the prediction model used by the predicting section 12 may include:

### (Prediction Model 1)

a prediction model for predicting, from pigment information and features of waste plastic, color information which indicates a color obtained by applying a pigment indicated by the pigment information to the waste plastic; and

### (Prediction Model 2)

a prediction model for predicting, from color information and features of waste plastic, pigment information which indicates a pigment that imparts, to the waste plastic, a color indicated by the color information.

Further, the predicting section 12 uses these prediction models to carry out at least one of the following processes:

### (Predicting Process 1)

a process of predicting, from the pigment information acquired by the acquiring section 11 and the features of the waste plastic, color information which indicates a color corresponding to the pigment information; and

### (Predicting Process 2)

a process of predicting, from the color information acquired by the acquiring section 11 and the features of the waste plastic, pigment information which indicates a pigment corresponding to the color information.

Any combination of the prediction models 1 and 2 and the predicting processes 1 and 2 may be employed. Specific examples of the predicting process which may be carried out by the predicting section 12 include the following four predicting processes.

### (Example 1-1: Prediction Model 1×Predicting Process 1)

A process of inputting the pigment information acquired by the acquiring section 11 and the features of the waste plastic to
a prediction model (prediction model 1 above) for predicting, from pigment information and features of waste plastic, color information which indicates a color obtained by applying a pigment indicated by the pigment information to the waste plastic, to predict color information which indicates a color corresponding to the pigment information acquired by the acquiring section 11.

### (Example 1-2: Prediction Model 1×Predicting Process 2)

A process of referring to the color information acquired by the acquiring section 11 and the features of the waste plastic, and using
a prediction model (prediction model 1 above) for predicting, from pigment information and features of waste plastic, color information which indicates a color obtained by applying a pigment indicated by the pigment information to the waste plastic, to predict pigment information which indicates a pigment corresponding to the color information acquired by the acquiring section 11.

In this case, as an example, the predicting section 12 carries out the process of predicting pigment information which indicates a pigment corresponding to the color information acquired by the acquiring section 11, by inputting a plurality of pigment information candidates to the prediction model 1 to predict a color corresponding to each of the candidates and carrying out a search process so that the color approaches a color indicated by the color information acquired by the acquiring section 11.

### (Example 2-1: Prediction Model 2×Predicting Process 1)

A process of referring to the pigment information acquired by the acquiring section 11 and the features of the waste plastic, and using
a prediction model (prediction model 2 above) for predicting, from color information and features of waste plastic, pigment information which indicates a pigment that imparts, to the waste plastic, a color indicated by the color information, to predict color information which indicates a color corresponding to the pigment information acquired by the acquiring section 11.

In this case, as an example, the predicting section 12 carries out the process of predict color information which indicates a color corresponding to the pigment information acquired by the acquiring section 11, by inputting a plurality of color information candidates to the prediction model 1 to predict pigment information corresponding to each of the candidates and carrying out a search process so that the pigment information approaches the pigment information acquired by the acquiring section 11.

### (Example 2-2: Prediction Model 2×Predicting Process 2)

A process of inputting the color information acquired by the acquiring section 11 and the features of the waste plastic to
a prediction model (prediction model 2 above) for predicting, from color information and features of waste plastic, pigment information which indicates a pigment that imparts, to the waste plastic, a color indicated by the color information, to predict pigment information which indicates a pigment corresponding to the color information acquired by the acquiring section 11.

A specific configuration of the prediction model used by the predicting section 12 does not limit the present example embodiment. As an example, the prediction model may be a deep learning model having a plurality of layers, or may be any other model. Further, the prediction model may be trained by supervised learning, or may be trained by unsupervised learning or semi-supervised learning.

As an example, the predicting section 12 may further predict at least one selected from the group consisting of:
a color which is obtained by applying a pigment indicated by the pigment information to virgin plastic or to mixed plastic that includes virgin plastic and waste plastic; and
a pigment which imparts, to virgin plastic or to mixed plastic that includes virgin plastic and waste plastic, a color indicated by the color information.

As an example, the mixed plastic may be plastic which includes virgin plastic and waste plastic in any proportions.

As an example, a prediction result derived by the predicting section 12 is
presented to a user via the output section 13 and/or
provided to an external production apparatus via the communicating section 30 to be used for color matching of a plastic material which includes waste plastic.

### (Output Section 13)

The output section 13 outputs a prediction result derived by the predicting section 12. As an example, the output section 13 may visually present, to a user, presentation information which includes the prediction result derived by the predicting section 12.

### (Registering Section 14)

The registering section 14 registers, in a database, information which includes at least one selected from the group consisting of the prediction result derived by the predicting section 12 and information referred to by the predicting section 12.

Specific examples of the prediction result derived by the predicting section 12 include:
color information CI which indicates a color corresponding to the pigment information PI acquired by the acquiring section 11; and
pigment information PI which indicates a pigment corresponding to the color information CI acquired by the acquiring section 11.

Specific examples of the information referred to by the predicting section 12 include:
pigment information PI which indicates a pigment candidate; and
color information CI which indicates a target color; and
a waste plastic feature WPF

### (Training Section 22)

The training section 22 refers to the information acquired by the acquiring section 21, to train a prediction model for predicting a mutual relationship among pigment information, features of waste plastic, and color information.

As an example, the training section 22 trains at least one of the following models:

### (Prediction Model 1)

a prediction model for predicting, from pigment information and features of waste plastic, color information which indicates a color obtained by applying a pigment indicated by the pigment information to the waste plastic; and

### (Prediction Model 2)

a prediction model for predicting, from color information and features of waste plastic, pigment information which indicates a pigment that imparts, to the waste plastic, a color indicated by the color information.

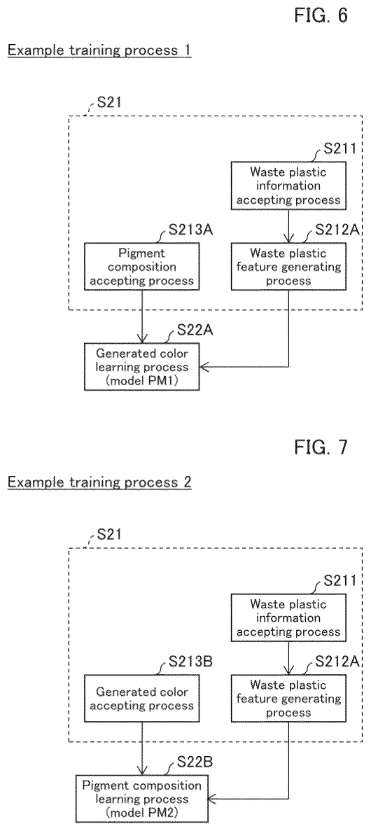

Further, the training section 22 may acquire a ground-truth label via the acquiring section 21, and train the prediction model by supervised learning in which the acquired ground-truth label is referred to. Example training processes carried out by the training section 22 will be described later with reference to FIGS. 6 to 8.

A specific configuration of the prediction model trained by the training section 22 does not limit the present example embodiment. As an example, the prediction model may be a deep learning model having a plurality of layers, or may be any other model. Further, the prediction model may be trained by supervised learning, or may be trained by unsupervised learning or semi-supervised learning.

The prediction model having been trained by the training section 22 is stored in, for example, a storage section 20 and referred to in an inference phase. As an example, the prediction model having been trained by the training section 22 is used by the predicting section 12 for the predicting process.

### (Example Training Processes Carried Out by Training Section 22)

Specific examples of the training process carried out by the training section 22 are described here with reference to FIGS. 6 to 8.

### (Example Training Process 1)

FIG. 6 is a diagram illustrating an example training process 1 carried out by the training section 22. The present example includes an acquiring process S21 and a generated color learning process S22A, as illustrated in FIG. 6. The acquiring process S21 of the present example includes a waste plastic information accepting process S211, a waste plastic feature generating process S212A, and a pigment composition accepting process S213A.

### (Waste Plastic Information Accepting Process S211)

In the waste plastic information accepting process S211, as an example, the acquiring section 21 acquires a waste plastic information WPI regarding waste plastic of interest. As an example, the waste plastic information WPI may include information regarding waste plastic, information regarding virgin plastic, or information regarding mixed plastic which includes virgin plastic and waste plastic.

### (Waste Plastic Feature Generating Process S212A)

In the waste plastic feature generating process S212A, as an example, the feature generating section 111 refers to the waste plastic information WPI regarding waste plastic of interest acquired by the acquiring section 21, to generate a waste plastic feature WPF regarding the waste plastic of interest.

### (Pigment Composition Accepting Process S213A)

In the pigment composition accepting process S213A, as an example, the acquiring section 21 acquires pigment information PI which is pigment composition information to be applied to the waste plastic.

### (Generated Color Learning Process S22A)

In the generated color learning process S22A, as an example, the training section 22 inputs training data acquired by the acquiring section 21, to a prediction model (model PM1) for predicting, from pigment information PI and a waste plastic feature WPF, color information CI which indicates a color obtained by applying a pigment indicated by the pigment information PI to the waste plastic. The training data includes:
pigment information PI; and
a waste plastic feature WPF, and the training data is associated with
an actual color (ground-truth label) obtained by applying a pigment indicated by the pigment information PI to the waste plastic.

The training section 22 then updates one or more parameters of the prediction model, so that a color indicated by the prediction result PRED outputted by the prediction model which has the training data inputted thereto approaches the color indicated by the ground-truth label.

### (Example Training Process 2)

FIG. 7 is a diagram illustrating an example training process 2 carried out by the training section 22.

The present example includes an acquiring process S21 and a pigment composition learning process S22B, as illustrated in FIG. 7. The acquiring process S21 of the present example includes a waste plastic information accepting process S211, a waste plastic feature generating process S212A, and a generated color accepting process S213B. In the present example, only the generated color accepting process S213B and the pigment composition learning process S22B are described. The other processes are each the same as the corresponding process described in the example training process above, and the descriptions thereof are therefore omitted here.

### (Generated Color Accepting Process S213B)

In the generated color accepting process S213B, as an example, the acquiring section 21 acquires color information CI which is generated color information regarding waste plastic.

### (Pigment Composition Learning Process S22B)

In the pigment composition learning process S22B, as an example, the training section 22 inputs training data acquired by the acquiring section 21, to a prediction model (model PM2) for predicting, from color information CI and a waste plastic feature WPF, pigment information PI which indicates a pigment that imparts, to the waste plastic, a color indicated by the color information CI. The training data includes:
color information CI; and
a waste plastic feature WPF, and the training data is associated with
pigment information (ground-truth label) which indicates an actual pigment that imparts, to the waste plastic, a color indicated by the color information CI. The training section 22 then updates one or more parameters of the prediction model, so that the pigment information indicated by the prediction result PRED outputted by the prediction model which has the training data inputted thereto approaches pigment information indicated by the ground-truth label.

### (Example Training Process 3)

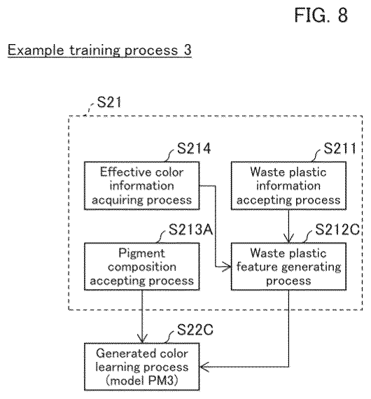

FIG. 8 is a diagram illustrating an example training process 3 carried out by the training section 22.

The present example includes an acquiring process S21 and a generated color learning process S22C, as illustrated in FIG. 8. The acquiring process S21 of the present example includes a waste plastic information accepting process S211, a waste plastic feature generating process S212C, an effective color information acquiring process S214, and a pigment composition accepting process S213A. In the present example, only the waste plastic feature generating process S212C, the effective color information acquiring process S214, and the generated color learning process S22C are described. The other processes are each the same as the corresponding process described in an example training process above, and the descriptions thereof are therefore omitted here.

### (Effective Color Information Acquiring Process S214)

In the effective color information acquiring process S214, the acquiring section 21 acquires effective color information. The effective color information is an example of the reference information RI described above. As an example, the effective color information can include:
information on colors obtained by actually applying each of a plurality of types of pigments to each of a plurality of types of waste plastic; and
information which indicates the effectiveness (affecting condition, the degree of color production) of each of one or more pigments against each of one or more types of waste plastic.

For example, the effective color information can include
information which indicates that in a case of using a pigment D1, the waste plastic of a type P1 has a degree of color production of approximately 0.8 with respect to a virgin material, and in a case of using a pigment D2, the waste plastic of the type P1 has a degree of color production of approximately 1.2 with respect to the virgin material.

As an example, the above effective color information may be stored in the storage section 20 or the database 52, so as to be in a form capable of being referred to by another external apparatus which is connected to the information processing system 1A via the network N.

### (Waste Plastic Feature Generating Process S212C)

In the waste plastic feature generating process S212C, as an example, the feature generating section 111 refers to the waste plastic information WPI regarding the waste plastic of interest and the effective color information which includes information on the colors obtained by actually applying each of a plurality of types of pigments to each of a plurality of types of waste plastic to generate a waste plastic feature WPF regarding the waste plastic of interest. The waste plastic information WPI and the effective color information are acquired by the acquiring section 21.

### (Generated Color Learning Process S22C)

In the generated color learning process S22C, as an example, the training section 22 inputs training data acquired by the acquiring section 21, to a prediction model (model PM3) for predicting, from pigment information PI and a waste plastic feature WPF which is generated with reference to waste plastic information WPI and effective color information, color information CI which indicates a color obtained by applying a pigment indicated by the pigment information PI to the waste plastic. The training data includes:
pigment information PI; and
a waste plastic feature WPF generated with reference to waste plastic information WPI and effective color information, and the training data is associated with
an actual color (ground-truth label) obtained by applying a pigment indicated by the pigment information PI to the waste plastic.

The training section 22 then updates one or more parameters of the prediction model, so that a color indicated by the prediction result PRED outputted by the prediction model which has the training data inputted thereto approaches the color indicated by the ground-truth label.

As an example, the model PM3 may be a prediction model for predicting color information CI which indicates the colors obtained by actually applying each of a plurality of types of pigments to each of a plurality of types of waste plastic, i.e., may be a prediction model for predicting the effective color information.

As an example, the ground-truth label associated with the training data may be the colors obtained by actually applying each of the plurality of types of pigments to each of the plurality of types of waste plastic, i.e., may be the effective color information.

As an example, the concentration of a pigment contained in a mixture obtained by applying a pigment to waste plastic may be determined so as to be any concentration.

### (Example Predicting Processes Carried Out by Predicting Section 12)

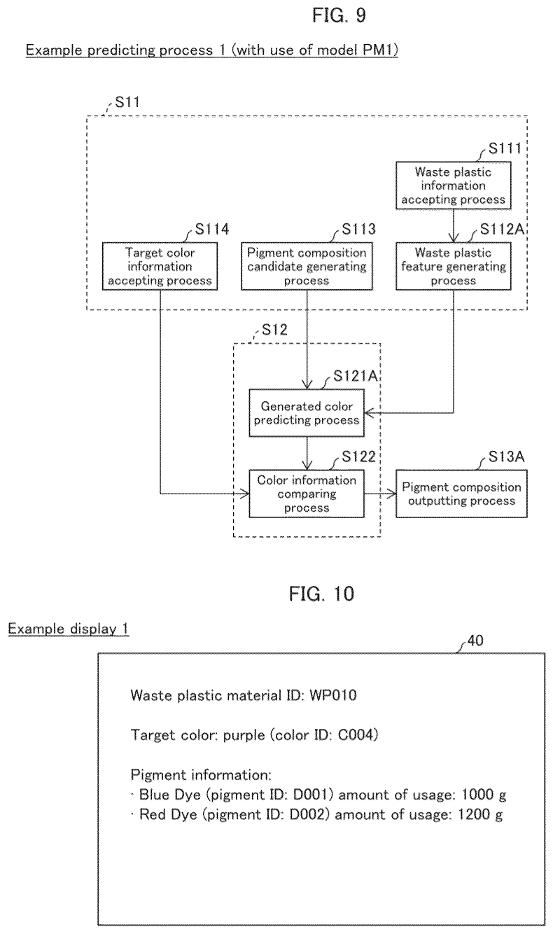

Specific examples of the predicting process carried out by the predicting section 12 are described here with reference to FIGS. 9 to 15.

### (Example Predicting Process 1)

FIG. 9 is a diagram illustrating an example predicting process 1 carried out by the predicting section 12. The present example includes an acquiring process S11, a predicting process S12, and a pigment composition outputting process S13A, as illustrated in FIG. 9. The acquiring process S11 of the present example includes a waste plastic information accepting process S111, a waste plastic feature generating process S112A, a pigment composition candidate generating process S113, and a target color information accepting process S114. The predicting process S12 of the present example includes a generated color predicting process S121A and a color information comparing process S122.

### (Waste Plastic Information Accepting Process S111)

In the waste plastic information accepting process S111, as an example, the acquiring section 11 acquires waste plastic information WPI regarding waste plastic of interest.

### (Waste Plastic Feature Generating Process S112A)

In the waste plastic feature generating process S112A, as an example, the feature generating section 111 refers to the waste plastic information WPI regarding waste plastic of interest acquired by the acquiring section 11, to generate a waste plastic feature WPF regarding the waste plastic of interest.

### (Pigment Composition Candidate Generating Process S113)

In the pigment composition candidate generating process S113, as an example, the acquiring section 11 generates pigment information PI, which is pigment composition candidate information that indicates a usable pigment composition. As an example, the pigment information PI generated by the acquiring section 11 may be a plurality of pieces of pigment composition candidate information. As an example, the acquiring section 11 may acquire pigment information PI which indicates a pigment candidate.

### (Target Color Information Accepting Process S114)

In the target color information accepting process S114, as an example, the acquiring section 11 acquires color information CI which indicates a target color. As an example, the color information CI acquired by the acquiring section 11 is target color information which indicates a color that serves as a target.

### (Generated Color Predicting Process S121A)

In the generated color predicting process S121A, as an example, the predicting section 12 uses a prediction model to predict, from the pigment information PI acquired by the acquiring section 11 and the waste plastic feature WPF, color information CI which indicates a color corresponding to the pigment information PI. In this prediction, as an example, the predicting section 12 uses, as the prediction model, a trained model for predicting, from pigment information PI and a waste plastic feature WPF, color information CI which indicates a color obtained by applying a pigment indicated by the pigment information PI to the waste plastic, i.e., uses, as the prediction model, the model PM1 that has been trained. In this case, as an example, the predicting section 12 inputs a plurality of pigment information candidates PI to the model PM1, to predict the color information CI corresponding to each of the candidates.

### (Color Information Comparing Process S122)

In the color information comparing process S122, as an example, the predicting section 12 compares the color information CI predicted with use of the model PM1 with the color information CI which is a target color information acquired by the acquiring section 11. With this, as an example, the predicting section 12 further predicts pigment information PI which indicates a pigment composition corresponding to the color information CI, which is the target color information acquired by the acquiring section 11, by carrying out a search process so that the predicted color information CI approaches the color information CI, which is the target color information acquired by the acquiring section 11.

### (Pigment Composition Outputting Process S13A)

In the pigment composition outputting process S13A, as an example, the output section 13 outputs pigment information PI, i.e., a pigment composition, included in the prediction result PRED derived by the predicting section 12.

### (Example Output Result Display 1 Produced by Output Section 13)

FIG. 10 is a representation of an example output result display 1 produced by the output section 13 in the pigment composition outputting process S13A described with reference to FIG. 9. As an example, the output section 13 visually presents, to a user, via the input-output section 40, presentation information which includes the prediction result PRED derived by the predicting section 12. The example display 1 illustrated in FIG. 10 is an example display of:
an ID assigned to each waste plastic material;
color information CI, which is information on a target color; and
pigment information PI which indicates the composition of a pigment that imparts the target color to a waste plastic material,
the example display being produced via the input-output section 40. Although the amounts of usage in the pigment information are indicated by weight in the example display in FIG. 10, such a manner of indication does not limit the present example. For example, the amount of usage in the pigment information may be indicated by a proportion (percentage) with respect to the total weight of waste plastic used.

### (Example Predicting Process 2)

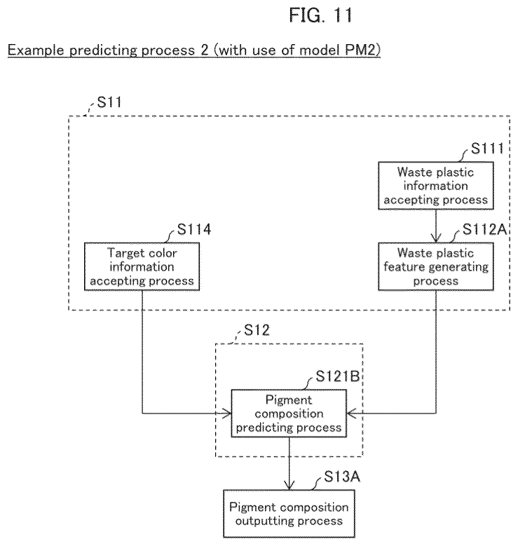

FIG. 11 is a diagram illustrating an example predicting process 2 carried out by the predicting section 12. The present example includes an acquiring process S11, a predicting process S12, and a pigment composition outputting process S13A, as illustrated in FIG. 11. The acquiring process S11 of the present example includes a waste plastic information accepting process S111, a waste plastic feature generating process S112A, and a target color information accepting process S114. The predicting process S12 of the present example includes a pigment composition predicting process S121B. In the present example, only the pigment composition predicting process S121B is described. The other processes are each the same as the corresponding process described in the example predicting process above, and the descriptions thereof are omitted here.

### (Pigment Composition Predicting Process S121B)

In the pigment composition predicting process S121B, as an example, the predicting section 12 uses a prediction model to predict, from the color information CI acquired by the acquiring section 11 and the waste plastic feature WPF, pigment information PI which indicates a pigment corresponding to the color information CI. In this prediction, as an example, the predicting section 12 uses, as the prediction model, a trained model for predicting, from color information CI and a waste plastic feature WPF, pigment information PI which indicates a pigment that imparts, to the waste plastic, a color indicated by the color information CI, i.e., uses, as the prediction model, the model PM2 that has been trained.

In other words, as an example, the predicting section 12 inputs the color information CI acquired by the acquiring section 11 and the waste plastic feature WPF to the model PM2, to predict pigment information PI which indicates a pigment corresponding to the color information CI acquired by the acquiring section 11.

### (Example Predicting Process 3)

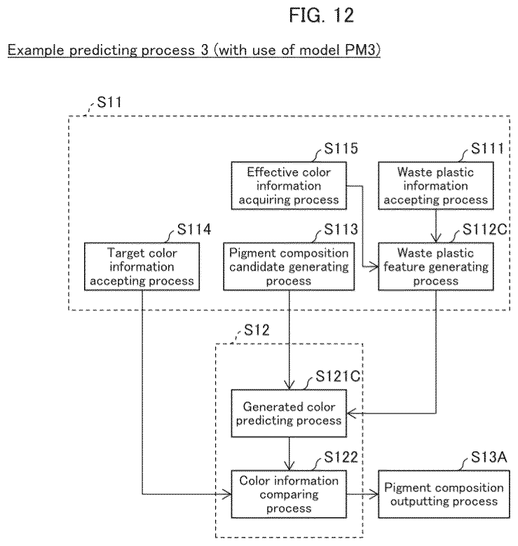

FIG. 12 is a diagram illustrating an example predicting process 3 carried out by the predicting section 12. The present example includes an acquiring process S11, a predicting process S12, and a pigment composition outputting process S13A, as illustrated in FIG. 12. The acquiring process S11 of the present example includes a waste plastic information accepting process S111, a waste plastic feature generating process S112C, a pigment composition candidate generating process S113, a target color information accepting process S114, and an effective color information acquiring process S115. The predicting process S12 of the present example includes a generated color predicting process S121C and a color information comparing process S122. In the present example, only the waste plastic feature generating process S112C, the effective color information acquiring process S115, and the generated color predicting process S121C are described. The other processes are each the same as the corresponding process described in an example predicting process above, and the descriptions thereof are therefore omitted here.

### (Effective Color Information Acquiring Process S115)

In the effective color information acquiring process S115, the acquiring section 11 acquires effective color information. The effective color information is an example of the reference information RI described above. The effective color information is described above in detail, and the description thereof is therefore omitted here.

### (Waste Plastic Feature Generating Process S112C)

In the waste plastic feature generating process S112C, as an example, the feature generating section 111 refers to the waste plastic information WPI regarding waste plastic of interest and the effective color information which includes information on the colors obtained by applying each of a plurality of types of pigments to each of a plurality of types of waste plastic, to generate a waste plastic feature WPF regarding the waste plastic of interest. The waste plastic information WPI and the effective color information are acquired by the acquiring section 21.

### (Generated Color Predicting Process S121C)

In the generated color predicting process S121C, as an example, the predicting section 12 uses a prediction model to predict, from the pigment information PI acquired by the acquiring section 11 and the waste plastic feature WPF generated with reference to the waste plastic information WPI and the effective color information, color information CI which indicates a color corresponding to the pigment information PI. In this prediction, as an example, the predicting section 12 uses, as the prediction model, a trained model for predicting, from pigment information PI and a waste plastic feature WPF which is generated with reference to waste plastic information WPI and effective color information, color information CI which indicates a color obtained by applying a pigment indicated by the pigment information PI to the waste plastic, i.e., uses, as the prediction model, the model PM3 that has been trained. In this case, as an example, the predicting section 12 inputs each of a plurality of pigment information candidates PI to the model PM3, to predict the color information CI corresponding to each of the candidates.

As an example, the predicting section 12 may use the model PM3 to predict, from the pigment information PI acquired by the acquiring section 11 and the waste plastic feature WPF generated with reference to the waste plastic information WPI and the effective color information, color information CI which includes effective color information corresponding to the pigment information PI.

As an example, the concentration of a pigment contained in a mixture obtained by applying a pigment to waste plastic may be determined so as to be any concentration.

As an example, the prediction result PRED which includes the effective color information predicted by the predicting section 12 may be stored in a storage medium such as the storage section 20. With this, as an example, the predicting section 12 may use a prediction model to further predict color information CI, from the pigment information PI and the waste plastic feature WPF generated with reference to the waste plastic information WPI and the effective color information included in the prediction result PRED.

### (Example Predicting Process 4)

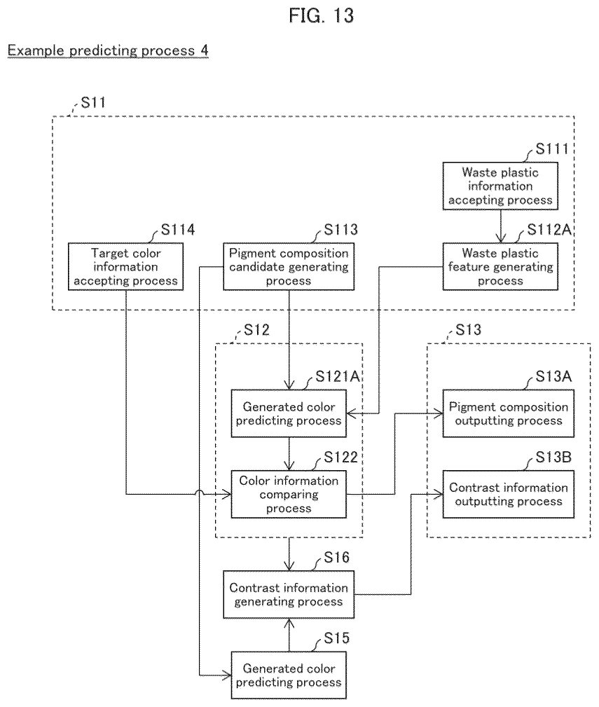

FIG. 13 is a diagram illustrating an example predicting process 4 carried out by the predicting section 12. The present example includes an acquiring process S11, a predicting process S12, an outputting process S13, a generated color predicting process S15, and a contrast information generating process S16, as illustrated in FIG. 13. The acquiring process S11 of the present example includes a waste plastic information accepting process S111, a waste plastic feature generating process S112A, a pigment composition candidate generating process S113, and a target color information accepting process S114. The predicting process S12 of the present example includes a generated color predicting process S121A and a color information comparing process S122. The outputting process S13 of the present example includes a pigment composition outputting process S13A and a contrast information outputting process S13B. In the present example, only the generated color predicting process S15, the contrast information generating process S16, and the contrast information outputting process S13B are described. The other processes are each the same as the corresponding process described in an example predicting process above, and the descriptions thereof are therefore omitted here.

### (Generated Color Predicting Process S15)

In the generated color predicting process S15, as an example, the predicting section 12 uses a prediction model to predict, from the pigment information PI acquired by the acquiring section 11, color information CI which indicates a color corresponding to the pigment information PI. As an example, the predicting section 12 uses the model PM1 to predict the color information CI which indicates a color obtained by applying a pigment indicated by the pigment information PI to virgin plastic. As an example, the predicting section 12 uses the model PM2 to further predict the pigment information PI which indicates a pigment that imparts, to virgin plastic, a color indicated by the color information CI.

### (Contrast Information Generating Process S16)

In the contrast information generating process S16, as an example, the predicting section 12 uses the color information CI obtained by applying a pigment indicated by the pigment information PI to waste plastic in the generated color predicting process S121A and the color information CI obtained by applying a pigment indicated by the pigment information PI to virgin plastic in the generated color predicting process S15, to further predict color information CI which indicates a color obtained by applying a pigment indicated by the pigment information PI to mixed plastic which includes virgin plastic and waste plastic. With this, as an example, the predicting section 12 generates contrast information which is obtained by performing a contrast between
the color information CI obtained by applying a pigment indicated by the pigment information PI to virgin plastic, and
the color information CI obtained by applying a pigment indicated by the pigment information PI to mixed plastic including virgin plastic and waste plastic.

As an example, the predicting section 12 may use the pigment information PI which indicates a pigment that imparts, to waste plastic, the target color indicated by the color information CI obtained in the generated color predicting process S121A and the pigment information PI which indicates a pigment that imparts, to virgin plastic, the target color indicated by the color information CI obtained by the generated color predicting process S15, to further predict pigment information PI which indicates a pigment that imparts, to mixed plastic which includes virgin plastic and waste plastic, the target color indicated by the color information CI. With this, as an example, the predicting section 12 may generate contrast information which is obtained by performing a contrast between
the pigment information PI which indicates a pigment that imparts, to virgin plastic, the target color indicated by the color information CI, and
pigment information PI which indicates a pigment that imparts, to mixed plastic including virgin plastic and waste plastic, the target color indicated by the color information CI.

### (Contrast Information Outputting Process S13B)

In the contrast information outputting process S13B, as an example, the output section 13 outputs the contrast information generated by the predicting section 12.

### (Example Output Result Display 2 Produced by Output Section 13)

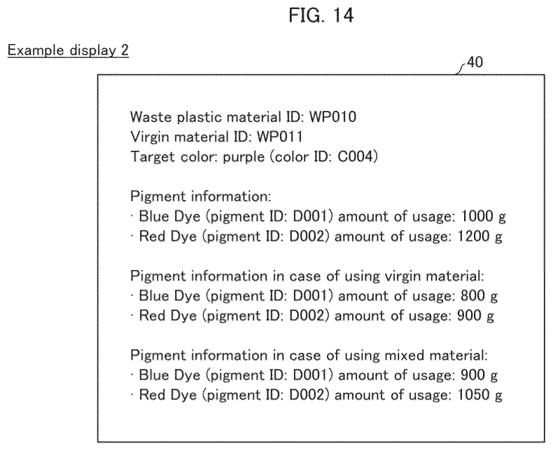

FIG. 14 is a representation of an example output result display 2 produced by the output section 13 in the pigment composition outputting process S13A and the contrast information outputting process S13B described with reference to FIG. 13. As an example, the output section 13 visually presents, to a user, via the input-output section 40, presentation information which includes the prediction result PRED derived by the predicting section 12. The example display 2 illustrated in FIG. 14 is an example display of:
an ID assigned to each waste plastic material;
an ID of virgin material plastic to be mixed into the waste plastic material;
color information CI which is information on a target color;
pigment information PI which indicates the composition of a pigment that imparts the target color to a waste plastic material;
pigment information PI which indicates the composition of a pigment that imparts the target color to a virgin plastic material (virgin material); and
pigment information PI which indicates the composition of a pigment that imparts the target color to mixed plastic material (mixed material) including a virgin plastic material and a waste plastic material, the example display being produced via the input-output section 40.

Although the amounts of usage in the pigment information are indicated by weight in the example display in FIG. 14, such a manner of indication does not limit the present example. For example, the amount of usage in the pigment information may be indicated by a proportion (percentage) with respect to the total weight of waste plastic used.

### (Example Predicting Process 5)

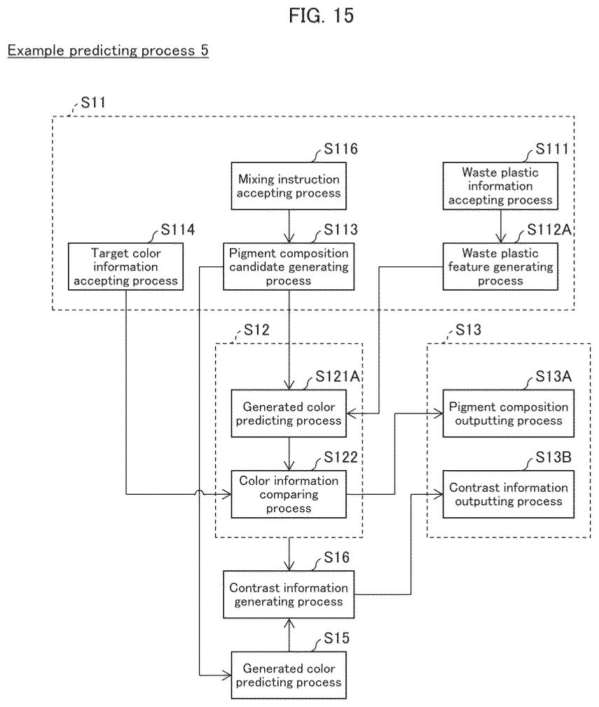

FIG. 15 is a diagram illustrating an example predicting process 5 carried out by the predicting section 12. The present example includes an acquiring process S11, a predicting process S12, an outputting process S13, a generated color predicting process S15, and a contrast information generating process S16, as illustrated in FIG. 15. The acquiring process S11 of the present example includes a waste plastic information accepting process S111, a waste plastic feature generating process S112A, a pigment composition candidate generating process S113, a target color information accepting process S114, and a mixing instruction accepting process S116. The predicting process S12 of the present example includes a generated color predicting process S121A and a color information comparing process S122. The outputting process S13 of the present example includes a pigment composition outputting process S13A and a contrast information outputting process S13B. In the present example, only the mixing instruction accepting process S116 is described. The other processes are each the same as the corresponding process described in an example predicting process above, and the descriptions thereof are omitted here.

### (Mixing Instruction Accepting Process S116)

In the mixing instruction accepting process S116, as an example, the acquiring section 11 acquires, from a user, instructions regarding mixing proportions of virgin plastic and waste plastic in mixed plastic. As an example, the mixing proportions of the virgin plastic and the waste plastic in the mixed plastic may be determined so as to be any proportions. Note that in the pigment composition candidate generating process S113 (described later), as an example, in accordance with the mixing proportions of the virgin plastic and the waste plastic in the mixed plastic, the acquiring section 11 may generate pigment information PI, which is pigment composition candidate information that indicates a usable pigment composition.

### (Example Advantage of Information Processing Apparatus 100A)

As above, in the information processing apparatus 100A,
the pigment information which indicates a pigment candidate is acquired, and
color information which indicates a color corresponding to the pigment information is predicted from the pigment information and the features of the waste plastic.

Thus, the information processing apparatus 100A provides an example advantage of making it possible to suitably carry out, on the basis of pigment information, color matching prediction regarding a plastic material which includes waste plastic, in addition to the example advantage provided by the information processing apparatus 1.

In the information processing apparatus 100A,
the color information which indicates a target color is acquired, and
pigment information which indicates a pigment corresponding to the color information is predicted from the color information and the features of the waste plastic.

Thus, the information processing apparatus 100A provides an example advantage of making it possible to suitably carry out, on the basis of color information, color matching prediction regarding a plastic material which includes waste plastic, in addition to the example advantage provided by the information processing apparatus 1.

In the information processing apparatus 100A,
the features of the waste plastic are generated with reference to information regarding the waste plastic. Thus, the information processing apparatus 100A provides an example advantage of making it possible to transform information regarding waste plastic which includes non-numerical information into a form capable of being referred to by a machine-learned model, in addition to the example advantage provided by the information processing apparatus 1.

In the information processing apparatus 100A,
reference information which includes information on the colors obtained by applying each of a plurality of types of pigments to each of a plurality of types of waste plastic is further referred to, to generate the features of the waste plastic.

Thus, the information processing apparatus 100A provides an example advantage of making it possible to also refer to colors obtained by actually applying pigments to waste plastic, to carry out a color matching prediction, in addition to the example advantage provided by the information processing apparatus 1.

In the information processing apparatus 100A,
a prediction result derived by a predicting means is outputted.

Thus, the information processing apparatus 100A provides an example advantage of making it possible to suitably check a prediction result, in addition to the example advantage provided by the information processing apparatus 1.

In the information processing apparatus 100A, at least one selected from the group consisting of:
a color which is obtained by applying a pigment indicated by the pigment information to virgin plastic or to mixed plastic that includes virgin plastic and waste plastic; and
a pigment which imparts, to virgin plastic or to mixed plastic that includes virgin plastic and waste plastic, a color indicated by the color information is further predicted, and
presentation information which includes a prediction result derived by the predicting means is visually presented to a user.

Thus, the information processing apparatus 100A provides an example advantage of making it possible to carry out a color matching prediction according to the mixing proportions of virgin plastic and waste plastic, in addition to the example advantage provided by the information processing apparatus 1.

In the information processing apparatus 100A,
information which includes at least one selected from the group consisting of a prediction result derived by a predicting means and information referred to by the predicting means is registered in a database.

Thus, the information processing apparatus 100A provides an example advantage of making it possible to suitably use a prediction result derived by a predicting means and information referred to by the predicting means, in addition to the example advantage provided by the information processing apparatus 1.

In the information processing apparatus 100A,
a trained model for predicting, from pigment information and features of waste plastic, color information which indicates a color that is obtained by applying a pigment indicated by the pigment information to the waste plastic is used as the prediction model. Thus, the information processing apparatus 100A provides an example advantage of making it possible to carry out a color matching prediction with use of a model for predicting color information from pigment information and features of waste plastic, in addition to the example advantage provided by the information processing apparatus 1.

In the information processing apparatus 100A,
a trained model for predicting, from color information and features of waste plastic, pigment information which indicates a pigment that imparts, to the waste plastic, a color indicated by the color information is used as the prediction model. Thus, the information processing apparatus 100A provides an example advantage of making it possible to carry out a color matching prediction with use of a model for predicting pigment information from color information and features of waste plastic, in addition to the example advantage provided by the information processing apparatus 1.

### Third Example Embodiment

The following description will discuss, in detail, a third example embodiment which is an example embodiment of the present invention, with reference to the drawings. A component having the same function as a component described in the above example embodiment is assigned the same reference sign, and the description thereof is omitted where appropriate. It should be noted that the applicability of the techniques adopted in the present example embodiment is not limited to the present example embodiment. That is, the techniques adopted in the present example embodiment can be adopted in another example embodiment included in the present disclosure, to the extent of constituting no specific technical obstacle. Further, the techniques illustrated in the drawings referred to for the description of the present example embodiment can be adopted in another example embodiment included in the present disclosure, to the extent of constituting no specific technical obstacle.

### (Configuration of Information Processing System 1B)

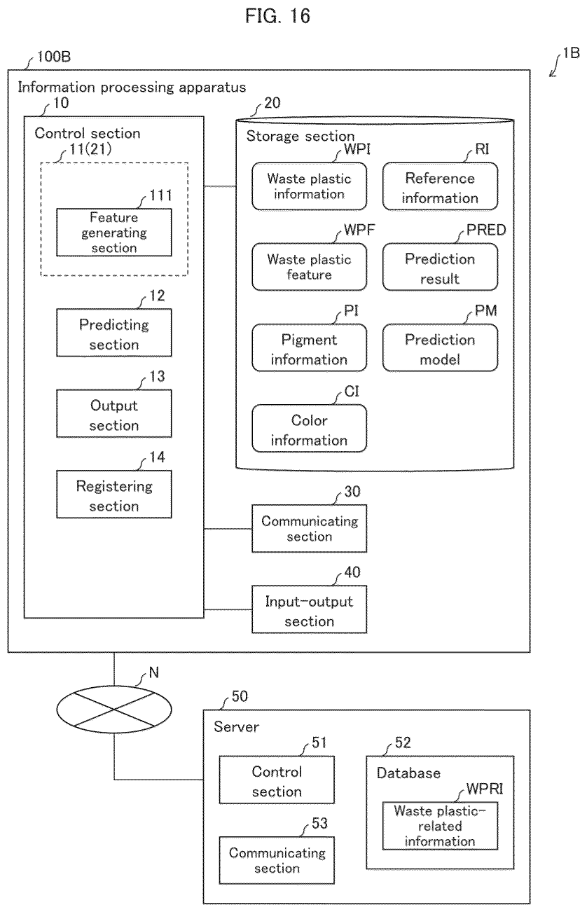

The configuration of an information processing system 1B in accordance with the present example embodiment is described here with reference to FIG. 16. FIG. 16 is a block diagram illustrating the configuration of the information processing system 1B. The information processing system 1B includes an information processing apparatus 100B and a server 50 connected to the information processing apparatus 100B via a network N, as illustrated in FIG. 16. The components of the information processing system 1B except the information processing apparatus 100B are the same as those of the information processing system 1A in accordance with the second example embodiment.

### (Configuration of Information Processing Apparatus 100B)

As illustrated in FIG. 16, the information processing apparatus 100B includes the components of the information processing apparatus 100A in accordance with the second example embodiment except a training section 22. The other components are the same as those of the information processing apparatus 100A.

As above, the information processing apparatus 100B includes:
an acquiring means (acquiring section 11(21)) for acquiring one of pieces of information which are color information and pigment information, and features of waste plastic;
a predicting means (predicting section 12) for predicting the other one of the pieces of information from information acquired, with use of a prediction model which has learned a mutual relationship among pigment information, features of waste plastic, and color information;
an output means (output section 13) for outputting a prediction result derived by the predicting means; and
a registering means (registering section 14) for registering, in a database, information which includes at least one selected from the group consisting of the prediction result derived by the predicting means and information referred to by the predicting means.

This configuration also provides the various example advantages in accordance with the example embodiments above.

### Software Implementation Example

Some or all of the functions of each of the information processing apparatuses 1, 2, 100A, and 100B (hereinafter, also referred to as “each apparatus above”) may be implemented by hardware such as an integrated circuit (IC chip), or may be implemented by software.

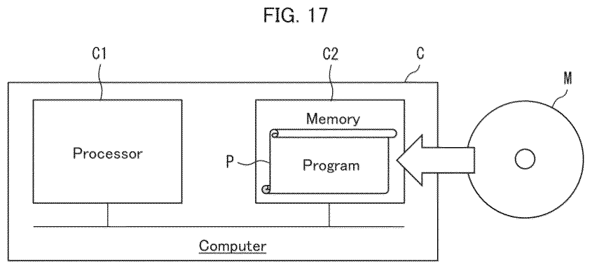

In the latter case, each apparatus above is provided by, for example, a computer that executes instructions of a program that is software implementing the functions. An example (hereinafter, computer C) of such a computer is illustrated in FIG. 17. FIG. 17 is a block diagram illustrating a hardware configuration of the computer C which functions as each apparatus above.

The computer C includes at least one processor C1 and at least one memory C2. The memory C2 has recorded thereon a program P for causing the computer C to operate as each apparatus above. The processor C1 of the computer C retrieves the program P from the memory C2 and executes the program P, so that the functions of each apparatus above are implemented.

Examples of the processor C1 can include a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. Examples of the memory C2 can include a flash memory, a hard disk drive (HDD), a solid state drive (SSD), and a combination thereof.

The computer C may further include a random access memory (RAM) into which the program P is loaded at the time of execution and in which various kinds of data are temporarily stored. The computer C may further include a communication interface via which data is transmitted to and received from another apparatus. The computer C may further include an input-output interface via which input-output equipment such as a keyboard, a mouse, a display, or a printer is connected.

The program P can be recorded on a non-transitory tangible recording medium M capable of being read by the computer C. The recording medium M can be, for example, a tape, a disk, a card, a semiconductor memory, a programmable logic circuit, or the like. The computer C can obtain the program P via such a recording medium M. The program P can be transmitted via a transmission medium. Examples of such a transmission medium can include a communication network and a broadcast wave. The computer C can obtain the program P also via such a transmission medium.

The above-described functions of each apparatus above may be implemented by a single processor provided in a single computer, may be implemented by the cooperation among a plurality of processors provided in a single computer, or may be implemented by the cooperation among a plurality of processors provided in a plurality of respective computers. Further, the program for causing each apparatus above to implement the above-described functions may be stored in a single memory provided in a single computer, may be stored in a distributed manner in a plurality of memories provided in a single computer, or may be stored in a distributed manner in a plurality of memories provided in a plurality of respective computers.

### Additional Remark a

The whole or part of the example embodiments disclosed above can be described as, but not limited to, the following supplementary notes, and the present invention can be altered in various ways by a skilled person in the art within the scope of the claims.

(Supplementary note A1)

An information processing apparatus, including: an acquiring means for acquiring one of pieces of information which are color information and pigment information, and features of waste plastic;
a predicting means for predicting the other one of the pieces of information from information acquired by the acquiring means, with use of a prediction model which has learned a mutual relationship among pigment information, features of waste plastic, and color information.

### (Supplementary Note A2)

The information processing apparatus described in supplementary note A1, in which
the acquiring means is configured to acquire the pigment information which indicate a pigment candidate, and
the predicting means is configured to predict, from the pigment information and the features of the waste plastic, color information which indicates a color corresponding to the pigment information.

### (Supplementary Note A3)

The information processing apparatus described in supplementary note A1, in which
the acquiring means is configured to acquire the color information which indicates a target color, and
the predicting means is configured to predict, from the color information and the features of the waste plastic, pigment information which indicates a pigment corresponding to the color information.

### (Supplementary Note A4)

The information processing apparatus described in any one of supplementary notes A1 to A3, in which
the acquiring means includes
   a feature generating means for generating the features of the waste plastic with reference to information regarding the waste plastic.

### (Supplementary Note A5)

The information processing apparatus described in supplementary note A4, in which
the feature generating means is configured to
   further refer to reference information which includes information on colors obtained by applying each of a plurality of types of pigments to each of a plurality of types of waste plastic, to generate the features of the waste plastic.

### (Supplementary Note A6)

The information processing apparatus described in any one of supplementary notes A1 to A3, further including
an output means for outputting a prediction result derived by the predicting means.

### (Supplementary Note A7)

The information processing apparatus described in supplementary note A6, in which
the predicting means is configured to further predict at least one selected from the group consisting of:
   a color which is obtained by applying a pigment indicated by the pigment information to virgin plastic or to mixed plastic that includes virgin plastic and waste plastic; and
   a pigment which imparts, to virgin plastic or to mixed plastic that includes virgin plastic and waste plastic, a color indicated by the color information, and
the output means is configured to
visually present, to a user, presentation information which includes the prediction result derived by the predicting means.

### (Supplementary Note A8)

The information processing apparatus described in any one of supplementary notes A1 to A3, further including
a registering means for registering, in a database, information which includes at least one selected from the group consisting of a prediction result derived by the predicting means and information referred to by the predicting means.

### (Supplementary Note A9)

The information processing apparatus described in any one of supplementary notes A1 to A3, in which
the predicting means is configured to
   use, as the prediction model, a trained model for predicting, from pigment information and features of waste plastic, color information which indicates a color that is obtained by applying a pigment indicated by the pigment information to the waste plastic.

### (Supplementary Note A10)

The information processing apparatus described in any one of supplementary notes A1 to A3, in which
the predicting means is configured to
   use, as the prediction model, a trained model for predicting, from color information and features of waste plastic, pigment information which indicates a pigment that imparts, to the waste plastic, a color indicated by the color information.

### (Supplementary Note A11)

An information processing apparatus, including:
an acquiring means for acquiring one of pieces of information which are color information and pigment information, and features of waste plastic; and
a training means for referring to information acquired by the acquiring means, to train a prediction model for predicting a mutual relationship among pigment information, features of waste plastic, and color information.

### Additional Remark B

The whole or part of the example embodiments disclosed above can be described as, but not limited to, the following supplementary notes, and the present invention can be altered in various ways by a skilled person in the art within the scope of the claims.

### (Supplementary Note B1)

An information processing method, including:
at least one processor acquiring one of pieces of information which are color information and pigment information, and features of waste plastic; and
the at least one processor predicting the other one of the pieces of information from information acquired by the acquiring, with use of a prediction model which has learned a mutual relationship among pigment information, features of waste plastic, and color information.

### (Supplementary Note B2)

The information processing method described in supplementary note B1, in which
in the acquiring, the at least one processor acquires the pigment information which indicates a pigment candidate, and
in the predicting, the at least one processor predicts, from the pigment information and the features of the waste plastic, color information which indicates a color corresponding to the pigment information.

### (Supplementary Note B3)

The information processing method described in supplementary note B1, in which
in the acquiring, the at least one processor acquires the color information which indicates a target color, and
in the predicting, the at least one processor predicts, from the color information and the features of the waste plastic, pigment information which indicates a pigment corresponding to the color information.

### (Supplementary Note B4)

The information processing method described in any one of supplementary notes B1 to B3, in which
the acquiring includes
the at least one processor generating the features of the waste plastic with reference to information regarding the waste plastic.

### (Supplementary Note B5)

The information processing method described in supplementary note B4, in which
in the generating, the at least one processor
   further refers to reference information which includes information on colors obtained by applying each of a plurality of types of pigments to each of a plurality of types of waste plastic, to generate the features of the waste plastic.

### (Supplementary Note B6)

The information processing method described in any one of supplementary notes B1 to B3, further including
the at least one processor outputting a prediction result derived by the predicting.

### (Supplementary Note B7)

The information processing method described in supplementary note B6, in which
in the predicting, the at least one processor further predicts at least one selected from the group consisting of:
   a color which is obtained by applying a pigment indicated by the pigment information to virgin plastic or to mixed plastic that includes virgin plastic and waste plastic; and
   a pigment which imparts, to virgin plastic or to mixed plastic that includes virgin plastic and waste plastic, a color indicated by the color information, and
in the outputting, the at least one processor
visually presents, to a user, presentation information which includes the prediction result derived by the predicting.

### (Supplementary Note B8)

The information processing method described in any one of supplementary notes B1 to B3, further including
the at least one processor registering, in a database, information which includes at least one selected from the group consisting of a prediction result derived by the predicting and information referred to in the predicting.

### (Supplementary Note B9)

The information processing method described in any one of supplementary notes B1 to B3, in which
in the predicting, the at least one processor
   uses, as the prediction model, a trained model for predicting, from pigment information and features of waste plastic, color information which indicates a color that is obtained by applying a pigment indicated by the pigment information to the waste plastic.

### (Supplementary Note B10)

The information processing method described in any one of supplementary notes B1 to B3, in which
in the predicting, the at least one processor
   uses, as the prediction model, a trained model for predicting, from color information and features of waste plastic, pigment information which indicates a pigment that imparts, to the waste plastic, a color indicated by the color information.

### (Supplementary Note B11)

An information processing method, including:
at least one processor acquiring one of pieces of information which are color information and pigment information, and features of waste plastic; and
the at least one processor referring to information acquired by the acquiring, to train a prediction model for predicting a mutual relationship among pigment information, features of waste plastic, and color information.

### Additional Remark C

The whole or part of the example embodiments disclosed above can be described as, but not limited to, the following supplementary notes, and the present invention can be altered in various ways by a skilled person in the art within the scope of the claims.

### (Supplementary Note C1)

An information processing program for causing a computer to function as an information processing apparatus,
the information processing program causing the computer to function as:
   an acquiring means for acquiring one of pieces of information which are color information and pigment information, and features of waste plastic;
   a predicting means for predicting the other one of the pieces of information from information acquired by the acquiring means, with use of a prediction model which has learned a mutual relationship among pigment information, features of waste plastic, and color information.

### (Supplementary Note C2)

The information processing program described in supplementary note C1, in which
the acquiring means is configured to acquire the pigment information which indicates a pigment candidate, and
the predicting means is configured to predict, from the pigment information and the features of the waste plastic, color information which indicates a color corresponding to the pigment information.

### (Supplementary Note C3)

The information processing program described in supplementary note C1, in which
the acquiring means is configured to acquire the color information which indicates a target color, and
the predicting means is configured to predict, from the color information and the features of the waste plastic, pigment information which indicates a pigment corresponding to the color information.

### (Supplementary Note C4)

The information processing program described in any one of supplementary notes C1 to C3, further causing the computer to function as
a feature generating means for referring to information regarding the waste plastic, to generate the features of the waste plastic.

### (Supplementary Note C5)

The information processing program described in supplementary note C4, in which
the feature generating means is configured to
   further refer to reference information which includes information on colors obtained by applying each of a plurality of types of pigments to each of a plurality of types of waste plastic, to generate the features of the waste plastic.

### (Supplementary Note C6)

The information processing program described in any one of supplementary notes C1 to C3, further causing the computer to function as
an output means for outputting a prediction result derived by the predicting means.

### (Supplementary Note C7)

The information processing program described in supplementary note C6, in which
the predicting means is configured to further predict at least one selected from the group consisting of:
   a color which is obtained by applying a pigment indicated by the pigment information to virgin plastic or to mixed plastic that includes virgin plastic and waste plastic; and
   a pigment which imparts, to virgin plastic or to mixed plastic that includes virgin plastic and waste plastic, a color indicated by the color information, and
the output means is configured to
visually present, to a user, presentation information which includes the prediction result derived by the predicting means.

### (Supplementary Note C8)

The information processing program described in any one of supplementary notes C1 to C3, further causing the computer to function as
a registering means for registering, in a database, information which includes at least one selected from the group consisting of a prediction result derived by the predicting means and information referred to by the predicting means.

### (Supplementary Note C9)

The information processing program described in any one of supplementary notes C1 to C3, in which
the predicting means is configured to
   use, as the prediction model, a trained model for predicting, from pigment information and features of waste plastic, color information which indicates a color that is obtained by applying a pigment indicated by the pigment information to the waste plastic.

### (Supplementary Note C10)

The information processing program described in any one of supplementary notes C1 to C3, in which
the predicting means is configured to
   use, as the prediction model, a trained model for predicting, from color information and features of waste plastic, pigment information which indicates a pigment that imparts, to the waste plastic, a color indicated by the color information.

### (Supplementary Note C11)

An information processing program for causing a computer to function as:
an acquiring means for acquiring one of pieces of information which are color information and pigment information, and features of waste plastic; and
a training means for referring to information acquired by the acquiring means, to train a prediction model for predicting a mutual relationship among pigment information, features of waste plastic, and color information.

### Additional Remark D

The whole or part of the example embodiments disclosed above can be described as, but not limited to, the following supplementary notes, and the present invention can be altered in various ways by a skilled person in the art within the scope of the claims.

### (Supplementary Note D1)

An information processing apparatus, including
at least one processor, the at least one processor carrying out:
an acquiring process of acquiring one of pieces of information which are color information and pigment information, and features of waste plastic; and
a predicting process of predicting the other one of the pieces of information from information acquired by the acquiring process, with use of a prediction model which has learned a mutual relationship among pigment information, features of waste plastic, and color information.

The information processing apparatus may further include a memory. The memory may have stored therein a program for causing the at least one processor to carry out each of the processes.

### (Supplementary Note D2)

The information processing apparatus described in supplementary note D1, in which
in the acquiring process, the at least one processor acquires the pigment information which indicates a pigment candidate, and
in the predicting process, the at least one processor predicts, from the pigment information and the features of the waste plastic, color information which indicates a color corresponding to the pigment information.

### (Supplementary Note D3)

The information processing apparatus described in supplementary note D1, in which
in the acquiring process, the at least one processor acquired the color information which indicates a target color, and
in the predicting process, the at least one processor predicts, from the color information and the features of the waste plastic, pigment information which indicates a pigment corresponding to the color information.

### (Supplementary Note D4)

The information processing apparatus described in any one of supplementary notes D1 to D3, in which
in the acquiring process, the at least one processor carries out
   a feature generating process of referring to information regarding the waste plastic, to generate the features of the waste plastic.

### (Supplementary Note D5)

The information processing apparatus described in supplementary note D4, in which
in the feature generating process, the at least one processor
   further refers to reference information which includes information on colors obtained by applying each of a plurality of types of pigments to each of a plurality of types of waste plastic, to generate the features of the waste plastic.

### (Supplementary Note D6)

The information processing apparatus described in supplementary note D1 to D3, in which
the at least one processor further carries out
an outputting process of outputting a prediction result derived by the predicting process.

### (Supplementary Note D7)

The information processing apparatus described in supplementary note D6, in which
in the predicting process, the at least one processor further predicts at least one selected from the group consisting of:
   a color which is obtained by applying a pigment indicated by the pigment information to virgin plastic or to mixed plastic that includes virgin plastic and waste plastic; and
   a pigment which imparts, to virgin plastic or to mixed plastic that includes virgin plastic and waste plastic, a color indicated by the color information, and
in the outputting process, the at least one processor
visually presents, to a user, presentation information which includes the prediction result derived by the predicting process.

### (Supplementary Note D8)

The information processing apparatus described in any one of supplementary notes D1 to D3, in which
the at least one processor further carries out
a registering process of registering, in a database, information which includes at least one selected from the group consisting of a prediction result derived by the predicting process and information referred to in the predicting process.

### (Supplementary Note D9)

The information processing apparatus described in any one of supplementary notes D1 to D3, in which
in the predicting process, the at least one processor
   uses, as the prediction model, a trained model for predicting, from pigment information and features of waste plastic, color information which indicates a color that is obtained by applying a pigment indicated by the pigment information to the waste plastic.

### (Supplementary Note D10)

The information processing apparatus described in any one of supplementary notes D1 to D3, in which
in the predicting process, the at least one processor
   uses, as the prediction model, a trained model for predicting, from color information and features of waste plastic, pigment information which indicates a pigment that imparts, to the waste plastic, a color indicated by the color information.

### (Supplementary Note D11)

An information processing apparatus, including
at least one processor, the at least one processor carrying out:
an acquiring process of acquiring one of pieces of information which are color information and pigment information, and features of waste plastic; and
a training process of referring to information acquired by the acquiring process, to train a prediction model for predicting a mutual relationship among pigment information, features of waste plastic, and color information.

### Additional Remark E

The whole or part of the example embodiments disclosed above can be described as, but not limited to, the following supplementary notes, and the present invention can be altered in various ways by a skilled person in the art within the scope of the claims.

### (Supplementary Note E1)

A non-transitory recording medium having recorded thereon an information processing program for causing a computer to function as an information processing apparatus,
the information processing program causing the computer to carry out:
   an acquiring process of acquiring one of pieces of information which are color information and pigment information, and features of waste plastic; and
   a predicting process of predicting the other one of the pieces of information from information acquired by the acquiring process, with use of a prediction model which has learned a mutual relationship among pigment information, features of waste plastic, and color information.

### REFERENCE SIGNS LIST

1, 2, 100A, 100B: Information processing apparatus
1A, 1B: Information processing system
10, 51: Control section
11, 21: Acquiring section
12: Predicting section
13: Output section
14: Registering section
20: Storage section
22: Training section
30. 53: Communicating section
40: Input-output section
50: Server
52: Database
111: Feature generating section
C1: Processor
C2: Memory

1. An information processing apparatus, comprising
at least one processor, the at least one processor carrying out
an acquiring process of acquiring one of pieces of information which are color information and pigment information, and features of waste plastic; and
a predicting process of predicting the other one of the pieces of information from information acquired by the acquiring process, with use of a prediction model which has learned a mutual relationship among pigment information, features of waste plastic, and color information.

2. The information processing apparatus according to claim 1, wherein
in the acquiring process and the predicting process, the at least one processor carries out at least one of the following processes:
a first process of
acquiring, through the acquiring process, the pigment information which indicates a pigment candidate, and
predicting, through the predicting process, color information which indicates a color corresponding to the pigment information, from the pigment information and the features of the waste plastic; and
a second process of
acquiring, through the acquiring process, the color information which indicates a target color, and
predicting, through the predicting process, pigment information which indicates a pigment corresponding to the color information, from the color information and the features of the waste plastic.

3. The information processing apparatus according to claim 1, wherein
in the acquiring process, the at least one processor carries out
a feature generating process of referring to information regarding the waste plastic, to generate the features of the waste plastic.

4. The information processing apparatus according to claim 3, wherein
in the feature generating process, the at least one processor
further refers to reference information which includes information on colors obtained by applying each of a plurality of types of pigments to each of a plurality of types of waste plastic, to generate the features of the waste plastic.

5. The information processing apparatus according to claim 1, wherein
in the predicting process, the at least one processor further predicts at least one selected from the group consisting of:
a color which is obtained by applying a pigment indicated by the pigment information to virgin plastic or to mixed plastic that includes virgin plastic and waste plastic; and
a pigment which imparts, to virgin plastic or to mixed plastic that includes virgin plastic and waste plastic, a color indicated by the color information, and
the at least one processor further carries out
an outputting process of visually presenting, to a user, presentation information which includes a prediction result derived by the predicting process.

6. The information processing apparatus according to claim 1, wherein
the at least one processor further carries out
a registering process of registering, in a database, information which includes at least one selected from the group consisting of a prediction result derived by the predicting process and information referred to in the predicting process.

7. The information processing apparatus according to claim 1, wherein
in the predicting process, the at least one processor uses, as the prediction model,
a trained model for predicting, from pigment information and features of waste plastic, color information which indicates a color that is obtained by applying a pigment indicated by the pigment information to the waste plastic, or
a trained model for predicting, from color information and features of waste plastic, pigment information which indicates a pigment that imparts, to the waste plastic, a color indicated by the color information.

8. An information processing apparatus, comprising
at least one processor, the at least one processor carrying out
an acquiring process of acquiring one of pieces of information which are color information and pigment information, and features of waste plastic; and
a training process of referring to information acquired by the acquiring process, to train a prediction model for predicting a mutual relationship among pigment information, features of waste plastic, and color information.

9. An information processing method, comprising:
at least one processor acquiring one of pieces of information which are color information and pigment information, and features of waste plastic; and
the at least one processor predicting the other one of the pieces of information from information acquired in the acquiring, with use of a prediction model which has learned a mutual relationship among pigment information, features of waste plastic, and color information.

10. A non-transitory recording medium storing a program for causing a computer to function as the information processing apparatus according to claim 1,
the program causing the computer to carry out:
the acquiring process; and
the predicting process.
